(19) United States
(12) Patent Application Publication
(10) Pub. No.: US 2002/0174017 A1
(43) Pub. Date: Nov. 21, 2002

(54) Developing property tax data

(76) Inventors: Somesh Singh, Houston, TX (US); Giridhar Iyer, Houston, TX (US)

Correspondence Address: iVita Corporation, 13111 Northwest Freeway, Suite 400, Houston, TX, 77040, US

(21) Appl. No.: 09/862,779

(22) Filed: May 21, 2001

(51) Int. Cl. G06F 17/60

(52) U.S. Cl. 705/19

(57) ABSTRACT

Property tax data may be mined from existing asset databases. These databases commonly do not communicate with other databases since they are developed for specialized purposes. By mining tax sensitive data from the databases, tax management software may develop information for property tax compliance or tax planning purposes. For example, information about property tax exemptions and possible exclusions may be mined from the data together with information about the assets' location which may be important to allocating assets to particular tax jurisdictions.

### BACKGROUND

This invention relates generally to the use of asset management databases, and particularly, the use of such databases to develop property tax data.

An asset management database is a database which includes information about corporate assets. Examples of asset databases include procurement databases such as Enterprise Resource Procurement (ERP) software databases and Supply Chain Management (SCM) software databases. In addition, asset management databases may include specialized asset management databases. The specialized asset management databases may include databases for the maintenance of factory assets or plant management software. In addition, asset management databases may include infrastructure management software such as software used to manage information technology assets, telephone assets, fleet assets, real estate and spare parts, to mention a few examples. The database may include data collected from location tracking systems, including global positioning systems, radio frequency or infrared identification systems, and also telemetry data provided by these and other automated technologies.

In many cases, asset management databases are developed by specialized vendors who have specialized knowledge of particular types of assets. Often these databases do not communicate well with other databases existent within a given enterprise. In particular, the financial software utilized for accounting and corporate tax purposes commonly does not interact with the asset management software. Generally asset management software packages for different applications do not communicate with one another.

Property tax is an annual local and/or state tax levied on the value of real and/or personal property owned by individuals and businesses. It differs from a sales tax that is typically levied when a transaction occurs. The categories of property tax vary from state to state but generally include personal property and real property.

In general, the development of information for paying property taxes is often done in a relatively haphazard fashion. For example, the tax department may query the plant department but the plant engineers have little incentive to spend the time and effort needed to accurately detail the plant assets. Moreover, the persons collecting the information commonly have little information about available exemptions and exclusions from the payment of property tax. Thus, in some cases, entities may pay property tax on equipment, such as pollution control equipment, that may be subject to a total or partial property tax exemption. Similarly, idled assets that have been replaced by other assets may be improperly included in the property tax calculation.

Since the database for equipment is often not up-to-date, a large number of ghost assets (assets that have been retired) continue to be a part of the tax base. This situation increases the tax liability of the enterprise.

Finally, in many cases, an enterprise may not know the precise location, over the period of the tax year, of many of its assets. Particularly with mobile assets, it may be incorrectly assumed that the mobile assets are resident in a home base tax jurisdiction when in fact, those assets may be absent from that home base during a substantial portion of the year. Since property taxes vary from jurisdiction to jurisdiction, in many cases the inability to determine where the asset was during the year may result in an improper tax calculation.

Property taxes in many jurisdictions are affected based on the utilization of the taxed equipment. Also, many jurisdictions have special exemptions or credits for environmental and other reasons.

Thus, there is a need for better ways to plan for, collect data for, and actually determine property taxes.

### BRIEF DESCRIPTION OF THE DRAWINGS

FIG. 1 is a block depiction of hardware in accordance where the one embodiment of the present invention;

FIG. 2 is a flow chart for software in accordance with one embodiment of the present invention; and

FIG. 3 is a block depiction of the flow, in accordance with one embodiment of the present invention, between various enterprise software packages.

### DETAILED DESCRIPTION

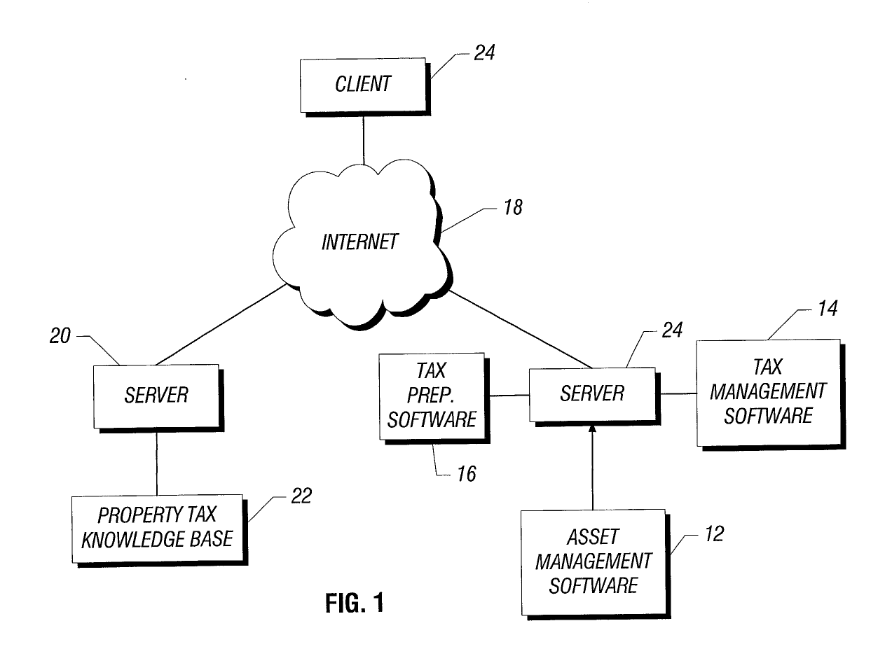

Referring to FIG. 1, a client 24 may run a particular software package or group of software packages. The client 24 may be owned by an enterprise that has access to a variety of software packages over the Internet 18. In one example, the client 24 may access a server 20 over the Internet 18 that in turn provides access to a property tax knowledge base 22. The property tax knowledge base 22 may be accessed by the client 24 to obtain specialized, local property tax information. In one embodiment, the base 22 may be maintained by a separate entity such as an accounting firm.

The property tax knowledge base 22 may provide information that a variety of clients 24 may need in order to determine property taxes in a variety of jurisdictions. Thus, the property tax knowledge base 22 has information about the particular characteristics of property taxes in different taxing jurisdictions. For example, the property tax knowledge base 22 may have information from local tax statutes, property tax definitions, information about exemptions, information about taxability and rates, filing requirements and filing deadlines. In particular, the base 22 may have detailed information about exemptions including abatements, pollution control certificates, and different tax credits and incentives.

The client 24 may also access a server 24 over the Internet 18. The server 24 may include tax management software 14. The tax management software 14 may be responsible for managing property taxes in one embodiment. The server 24 may also access a property tax preparation software package 16 in one embodiment. Finally, the server 24 may provide access to one or more asset management software packages 12.

While in the illustrated embodiment, three different software packages 12, 14 and 16 are all accessed through a single server 24, in some embodiments, each of these packages may be accessed separately over the Internet by a separate server. In still other cases, all of these packages 12, 14, and 16 may be running locally at a given enterprise client 24.

The asset management software 12, as described previously, may provide a variety of specialized asset management functions, including financial management, ERP, or SCM, to mention a few examples. In one embodiment, the asset management software 12 may not be tuned to the collection of information about property taxes.

However, the use of the data contained in the asset management software 12 may be advantageous in collecting information relating to property taxes. That is, because the asset management software 12 may have greater information about the assets than what is available from any other source, its data may be advantageously mined in connection with property tax matters.

For example, conventional financial software packages may have little asset information other than the actual book value of the asset. These financial software packages may not include detailed information about the locations of assets, the nature of the assets, and components associated with the assets. Thus, the superior knowledge gained through accessing the asset management software 12 database may enable the server 24 to advantageously develop information for the preparation of property tax returns under the control of the property tax management software 14. The preparation of the tax return may be done independently of the tax management software 14 and asset management software 12 in one embodiment.

Problems associated with collecting asset information from responsible personnel may be reduced by accessing detailed information that is available in asset management software packages 12. One reason these packages 12 are not accessed for this purpose is because an interface must be built between the various software packages. Thus, a specific interface must be provided to enable the tax management software 14 to interact with the asset management software 12. Once this interface is provided, however, the superior knowledge gained from the asset management software 12 may prove beneficial in preparing tax information in many cases.

As one example, the asset management software 12 may have detailed information about particular assets. It may include information such as the location of the asset which may be useful in connection with property tax determinations. The asset management software 16 may also include information about components of particular assets such as pollution control components that may be subject to property tax rebates or exemptions. In addition, the asset management software 12 may have information that particular assets have been replaced with other assets and this too may be information useful in determining property taxes.

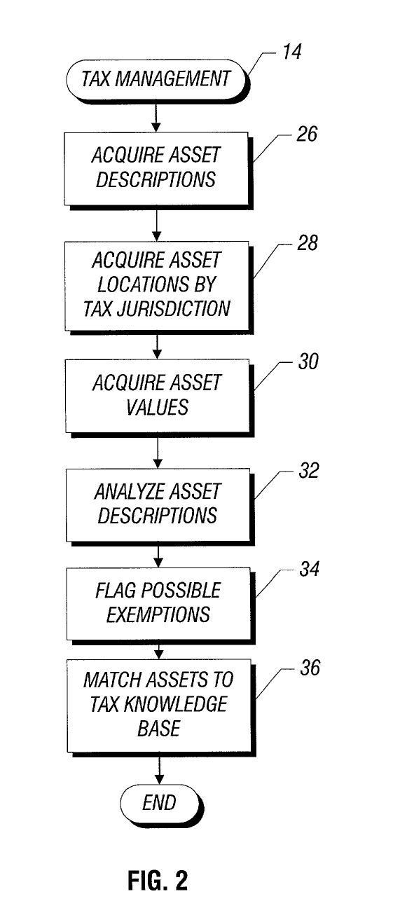

Turning next to FIG. 2, the tax management software 14 automatically acquires the asset descriptions, as indicated in block 26. It may do this by accessing the server 24 to gain access to the asset management software 12. From the database associated with the asset management software 12, the tax management software 14 may acquire detailed information about particular assets. This information may be mined for purposes of determining the most appropriate property tax determinations.

The locations of assets may then be acquired, by tax jurisdiction, as indicated in block 28. This information may be mined from asset management software 12. For example, that software may include information about the location of the asset.

In some cases, more detailed information may be available about asset location. For example, assets may be monitored using radio frequency systems to determine their present location. As another alternative, global positioning system tags may be provided on assets in order to determine their present location and to record a log of their previous locations. Software is commercially available to indicate the ongoing location of such assets. One such software package is available from Powerloc Technologies, Inc., Richmond Hill, Ontario, Canada L4B4N4. Thus, the amount of time that an asset has spent in a particular property tax jurisdiction may be automatically determined in one embodiment.

Thus, as indicated in block 28, more detailed asset location information may be acquired automatically from specialized software or from asset management software 12 in general. By obtaining the specific localities in which the asset was present during the taxable year, the tax liability for that particular asset may be more accurately determined.

The asset values may then be acquired as indicated in block 30. Conventionally, the asset values may be acquired automatically from financial software packages such as ledger software packages. In some cases, it may be sufficient to simply take the book value of the asset from existing software packages. In other cases, depending on specific tax laws, it may be possible to acquire other asset valuations.

The asset descriptions acquired from the sources described above may then be analyzed, as indicated in block 32 to determine whether any possible exemptions or redundancies exist. For example, it may be determined automatically that particular assets are subject to exemptions for pollution control or other reasons. In addition, it may be possible to automatically determine that particular assets have replaced other assets and that therefore those replaced or idled assets should not be counted in determining property taxes.

In block 34, possible tax exemptions may be flagged. The software 14 may look for certain key words such as “pollution” or other known exemption descriptors. Using information from the property tax knowledge base 22 in one embodiment, as indicated in block 34, these exemptions may then be flagged to reduce asset values for property tax purposes.

The assets are then matched to a tax knowledge base 22, as indicated in block 34. The assets, having been split up by property tax jurisdiction using the location information, may then be matched to the tax knowledge base 22 to determine the applicable tax standards for the appropriate tax jurisdiction. For example, the tax knowledge base 22 may determine, for a given asset, knowing how much time it spent in a given jurisdiction, how much property tax should be applied. Likewise, the tax knowledge base may be consulted to determine whether flagged potential exemptions are actual exemptions or not.

Output reports from the software 14 may be used for tax planning. In other embodiments, output reports from the software 14 may be provided to tax preparation software 16 for actual calculation of the returns. In one embodiment, the tax management software 14 provides an output in the form of assets grouped by tax jurisdiction locations. Appended to each asset may be information about potential exemptions or exclusions such as pollution exemptions or information about the replacement of assets by other assets.

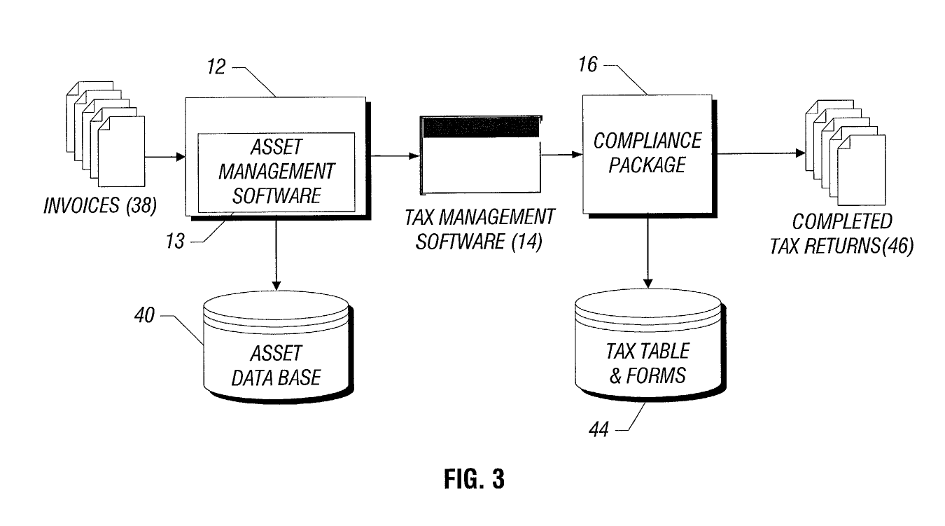

Thus, referring to FIG. 3, invoices 38 for new assets may be entered into asset management software 13 included as part of an asset management software package 12 in one embodiment. Thus, every time a new asset is purchased, it is routinely entered into appropriate asset management software 14 to build up an asset database 40. Tax management software 14 may receive the asset information from the asset management software 12. The software 14 may provide information to a tax preparation or compliance package 16 in one embodiment. The package 16 may consult tax tables and forms 44 in an appropriate database to provide completed tax returns 46 in a variety of different jurisdictions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
extracting asset data from an asset management database;
developing information about the value and location of a plurality of assets; and
applying a tax knowledge base to each of a plurality of assets based on the location of each asset.

2. The method of claim 1 including extracting asset data from an enterprise resource planning package.

3. The method of claim 1 including extracting asset data from a supply chain management software package.

4. The method of claim 1 including extracting asset data from a specialized asset management software package.

5. The method of claim 1 further including obtaining information about the ongoing location of an asset from an asset location software.

6. The method of claim 1 including accessing the tax knowledge base over the Internet.

7. The method of claim 1 including accessing the asset management database over the Internet.

8. The method of claim 1 including developing information from said asset management database useful in determining property tax exemptions.

9. The method of claim 1 including obtaining information from said asset management database useful in determining whether assets have been idled.

10. The method of claim 1 including determining how much time a particular asset spent in a given tax jurisdiction.

11. An article comprising a medium storing instructions that enable a processor-based system to:
extract asset data from an asset management database;
develop information about the value and location of a plurality of assets; and
apply a tax knowledge base to each of a plurality of assets based on the location of each asset.

12. The article of claim 11 further storing instructions that enable the processor-based system to automatically acquire information from asset tracking software.

13. The article of claim 11 further storing instructions that enable the processor-based system to access the tax knowledge base over the Internet.

14. The article of claim 11 further storing instructions that enable the processor-based system to extract asset data from an enterprise resource planning package.

15. The article of claim 11 further storing instructions that enable the processor-based system to extract asset data from a supply chain management software package.

16. The article of claim 11 further storing instructions that enable the processor-based system to access the asset management database over the Internet.

17. The article of claim 11 further storing instructions that enable the processor-based system to develop information from the asset management database useful in determining property tax exemptions.

18. The article of claim 11 further storing instructions that enable the processor-based system to obtain information from the asset management database useful in determining whether assets have been idled.

19. The article of claim 11 further storing instructions that enable the processor-based system to determine how much time an asset has spent in a given tax jurisdiction.

20. The article of claim 11 further storing instructions that enable the processor-based system to obtain asset value information from a financial accounting package.

21. A processor-based system comprising:
a processor; and
a storage coupled to said processor, said storage storing instructions that enable the processor to extract asset data from an asset management database, develop information about the value and location of a plurality of asset, and apply a tax knowledge base to each of a plurality of assets based on the location of each asset.

22. The system of claim 21 wherein said system is a server.

23. The system of claim 21 including an asset tracking software package.

24. The system of claim 21 including an enterprise resource planning software package.

25. The system of claim 21 including a supply chain management software package.

26. The system of claim 21 including an Internet connection, said processor adapted to access a tax knowledge base over the Internet.

27. The system of claim 21 wherein said storage stores an asset management software package and a property tax compliance package.
